(19) United States
(12) Patent Application Publication
(10) Pub. No.: US 2010/0055488 A1
(43) Pub. Date: Mar. 4, 2010

(54) NON-LINEAR WELDED BLANK AND METHOD OF REDUCING MASS

(75) Inventors: Jeffrey J. Gress, Royal Oak, MI (US); Venkat Aitharaju, Troy, MI (US)

Correspondence Address: MacMillan, Sobanski & Todd, LLC;One Maritime Plaza, 720 Water Street, 5th Floor, Toledo, OH, 43604, US

(73) Assignee: GM GLOBAL TECHNOLOGY OPERATIONS, INC., DETROIT, MI (US)

(21) Appl. No.: 12/547,020

(22) Filed: Aug. 25, 2009

Related U.S. Application Data
(60) Provisional application No. 61/093,313, filed on Aug. 30, 2008.

(51) Int. Cl. B32B 3/00; B21D 22/20; B32B 3/10

(52) U.S. Cl. 428/571; 72/360; 428/577

(57) ABSTRACT

A structural inner, such as a vehicular door inner, formed from an engineered non-linearly welded blank comprising blank sections of differing thickness, a method of reducing the mass of the blank and redistributing the stresses experienced thereby during a drawing process, and a modified three-piece draw die having a control split device adapted for stamping the blank and localizing, minimizing and redirecting a blank failure to a predetermined location, such as the speaker hole of the door, during the process.

### RELATED APPLICATIONS

This patent application claims priority to, and benefit from U.S. Provisional Patent Application Ser. No. 61/093,313, entitled “NON-LINEAR WELDED BLANK AND METHOD OF REDUCING MASS,” filed on Aug. 30, 2008; the disclosure of which is incorporated by reference herein.

### BACKGROUND OF THE INVENTION

1. Technical Field

The present invention relates to structural inners formed from tailor welded blanks, such as the type used in the manufacture of vehicle doors, and more particularly, to such a blank comprising a plurality of subparts joined by a non-linear weld and a method of reducing the mass of the same.

2. Background Art

Structural inners, such as the type used in vehicular door construction, provide support to interiorly housed components, and increase structural capacity. With respect to doors, for example, it is appreciated that inners provide side-impact reinforcement and form housings for electronic, door latching, and window components. The added weight of these inners, however, presents the increasing need to minimize the material associated therewith. As such, a multi-part light weight aluminum blank consisting of thin sheet metal sections of differing thickness (e.g., 0.8 and 1.8 mm) is typically used for construction, wherein the ratio of the sections results in the total mass of the inner. A vertical linear weld line is conventionally used to join the sections, and the thicker material is positioned towards the front of the inner so as to support the door hinges. The final location of the weld line is determined in part by the formability of the thin blank material near the linear weld.

As shown in prior art FIGS. 1 and 1a, for example, a vehicular inner 1 is stamped within a three-piece draw die 2 and produced from a tailor welded blank (TWB) 3. The TWB 3 typically consists of 0.8 mm stock (i.e., sheet metal blank, etc.) 4 and 1.8 mm stock 5 that are joined together along a common straight edge by a continuous linear weld 6. To decrease mass, the weld line 6 is positioned such that the thicker of the stock is minimized with respect to the overall blank area. In FIG. 1a, it is appreciated that forwardly shifting the linear weld line will account for a reduction in mass of the door inner as 1.8 mm material is replaced by 0.8 mm material. However, this results in various concerns, such as increased strain along the lower third of the line, the chance of failure in the thin material near the lower edge, and the need for additional draw dies and/or allowances for increased tonnage pads.

### BRIEF SUMMARY

The instant invention presents an innovative application of an engineered non-linear welded blank and method of reducing the mass of a structural inner that addresses the afore-mentioned concerns. Among other things, the inventive method is useful for producing a net mass saving in a structural inner, such as an automotive vehicle door inner, which increases fuel economy. By reducing the mass, the invention is further useful for reducing associated raw material costs, including reduced blank costs. The invention may be implemented using existing three-piece draw dies and requires minimal additional tryout. Moreover, the invention is useful for relocating the failure site to a new location more manageable by a controlled split device added to the draw die set. In this regard, the formability of the non-linear welded blank is also enhanced by the usage of the controlled split device. Finally, the invention is useful for providing improved blank nesting and fixturing for TWB manufacturing.

In a preferred embodiment, an objective of the invention is to reduce the amount of 1.8 mm stock used to manufacture door panels by relocating the weld line such that more of the 1.8 mm stock is replaced by 0.8 mm stock. The invention provides a means for redistributing the forming strains in a tailor welded blank, such that less thick material can be utilized in the draw stamping of the door inner. The curved or non-linear weld line presented strains the thin blank material more evenly in comparison to conventional linear weld applications, delays the initial necking, and the failure localization is relocated in line with the speaker hole. To effect the latter, a controlled split device in the draw die is utilized to maximize the benefit of the invention.

The above described and other features are exemplified by the following figures and detailed description.

### BRIEF DESCRIPTION OF THE DRAWINGS

Preferred embodiments of the invention are described in detail below with reference to the attached drawing figures of exemplary scale, wherein:

FIG. 1 is a schematic elevation of a prior art three piece draw die and tailor welded blank prior to stamping;

FIG. 1a is an elevation of a prior art door inner comprising first and second blanks having differing thickness and presenting a linear weld line having a lower third length, L1;

FIG. 2 is an elevation of a door inner comprising first and second blanks having differing thickness and presenting a non-linear weld line shifted forward and having a lower third length, L2, greater than L1, in accordance with a preferred embodiment of the invention;

FIG. 3 is a schematic elevation of a three-piece draw die having a control split device located inside the speaker hole, and a non-linearly welded TWB prior to stamping, in accordance with a preferred embodiment of the invention;

FIG. 4 is an elevation of a door inner comprising first and second blanks having differing thickness and presenting a non-linear weld line shifted forward and having a lower third length, L2, greater than L1, and upper section configured to clear the mirror patch, in accordance with a second preferred embodiment of the invention; and

FIG. 5 is a schematic diagram of the lower third profiles of the lines in FIGS. 1 and 2 or 4, particularly illustrating L1 and L2 under loading.

### DETAILED DESCRIPTION

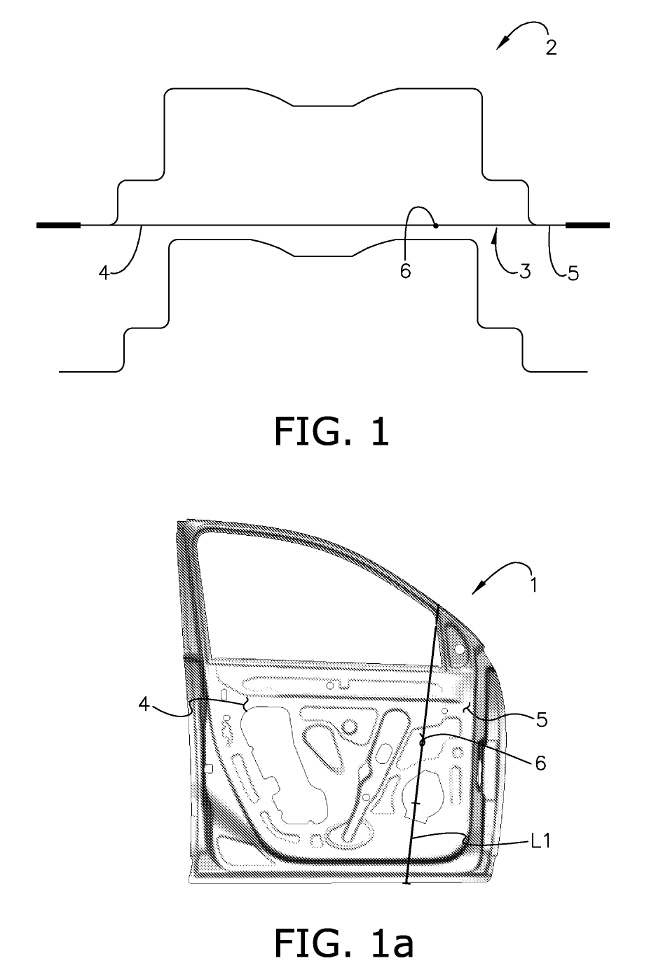

The present invention concerns a welded multi-part structural inner 10 presenting a contoured planar construction and a manufacturing application or method of reducing the mass of the same. More particularly, the invention provides an innovative approach to re-distribute the forming strains in a tailor welded blank (TWB) comprising relatively thick and thin steel sections (or “blanks”) 12,14, such that the amount of thin material utilized in the draw stamping of the inner 10 is increased in lieu of thick material (compare FIG. 1a and FIGS. 2 and 4).

As is known in the art, inners 10 are typically used to increase the structural capacity of or provide otherwise housing and/or reinforcing to an exterior structure, such as a front or rear vehicular door, as shown in the illustrated embodiment. Though described and illustrated with respect to a vehicular door embodiment, it is appreciated that the advantages of the present invention may be used with other applications, and with other vehicular structures, such as hoods, decklids, etc. That is to say, the following description of the preferred embodiments is merely exemplary in nature and is in no way intended to limit the invention, its application, or uses.

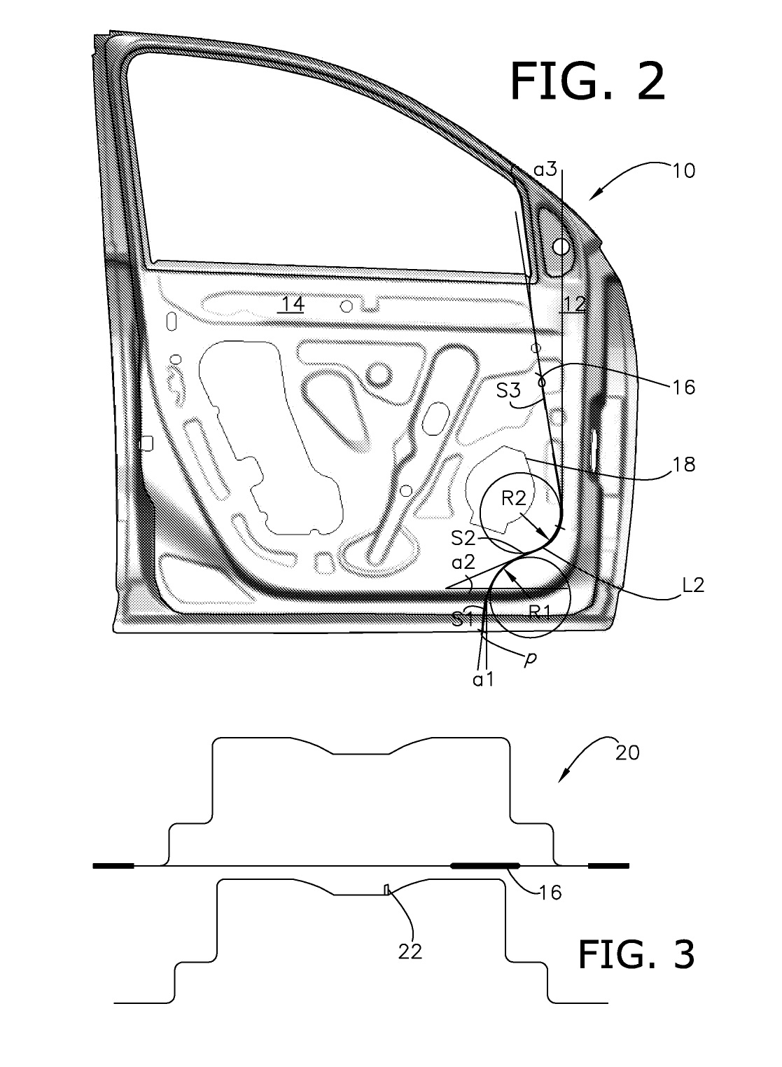

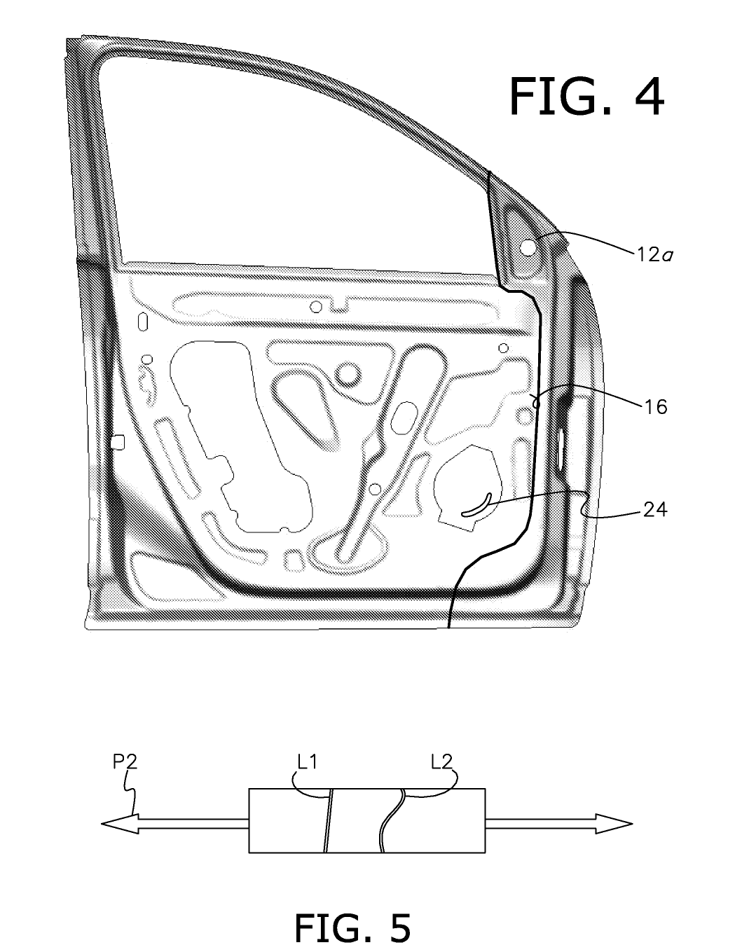

In a first aspect of the invention, and as best shown in FIGS. 2 and 4, a curved or non-linear blank weld line 16 is engineered to strain the thin blank material more evenly and delays the onset of initial necking at the lower end of the weld line, in comparison to prior art methods. More particularly, as it is appreciated that the greatest stress and therefore thinning experienced by the thin blank 14 occurs in the lower third of the weld height, the weld line 16 presents a sinuous or non-linear profile within the lower third. As shown in FIG. 5, the curvature of the line 16 at this location results in greater length, in comparison to linear weld lines, and consequently a greater cross-sectional area is available to transmit the lateral axial load, P2, caused during the forming of the lower front corner of the door. This reduces the stress experienced by the thin section 14 and enables the line 16 to be shifted forward, thereby reducing the thick blank contribution.

For example, in FIG. 2, a non-linear weld line 16 is shown consisting of three segments, S1, S2, and S3, and their intersections defined as three angles, a1 (0 (±15) degrees), a2 (70 (±15) degrees), and a3 (0 (±15) degrees), and two radii, R1 (100±50 mm), and R2 (100±50 mm), wherein the upper segment S1 and intersection extends within the non-critical upper two-thirds of the weld height. Based upon observation, the weld line angle at the lower third (a2 as measured from horizontal) is optimally 22.5 degrees. This further increases the area that carries the tensile load, localizes the failure, and moves the failure away from the lower edge of the door. Alternatively, it is appreciated that other non-linear configurations that offer an L2 greater than L1 may be employed to reduce the thick blank section. In FIG. 4, a four-bend, five-straight segment weld line 16 is shown, which further clears the door mirror patch 12a, and thereby provides thick blank material engagement that increases structural support.

As previously mentioned, the weld line contour is preferably optimized to relocate the failure to a suitable location, which allows further reduction of thick blank material near the lower edge of the inner 10. That is to say, optimal a2 raises the failure site away from the lower edge and towards the speaker hole 18, which enables the weld line 16 in the lower third to be further shifted forward. It is appreciated that forwardly shifting the weld line 16 in this area results in savings within the engineering scrap of the thin blank coil, which presents a maximum width or buy point at the intersection of S2 and S3. As such, it is appreciated that a wider thin blank 12 will not be required to supplant the thick material at this location; or, in other words reduction of the pitch of the thick blank 12 in this manner does not affect the mass penalty of the 0.8 mm blank 14.

In another aspect of the invention, a method of forming the inner 10 includes localizing and relocating the failure to a more manageable location, e.g., in line with the speaker hole 18 of the door. Here, it is appreciated that an otherwise conventional three-piece draw die 20 incorporating a controlled split device 22 may be used to control the formation of the split 24 during the drawing process, and that additional dies and/or tonnage pads are not required. That is to say, an existing three-piece production draw die can be retrofitted for use herein by adding the controlled split device 22 to engage the speaker scrap hole on the J-plane (i.e., the interior face generally parallel to the exterior surface of the door that defines the speaker hole, etc.) of the door inner 10. At this location, it is appreciated that the preferred split 24, post expansion, is entirely contained within the speaker hole 18, such that when the hole 18 is stamped the split 24 is discarded therewith.

In addition to the provisions of the non-linear weld 16, the formulation of a controlled split 24 can be used to great effectiveness for minimizing door mass, and increasing blank savings, and vehicle fuel economy, etc. More particularly, the control split 22 is used to effect material feed into the lower front corner of the inner 10 during the draw, as well as delay the localization and minimize the magnitude of the failure, which is preferably located within the shadow of the control split 24. As such, the split 24 is preferably located within the lower half of the hole 18 and spaced from the edge thereof, so as to leave room for expansion during drawing.

In a preferred embodiment, the controlled split device 22 is timed to engage the thin blank 14 at least 6 and more preferably 10 mm from bottom (i.e., the end of the drawing or stamping process). This, it is appreciated, increases the formability window of the split 24, and allows the weld line 16 at the thick blank buy point, p, to be moved even further forward. As a result, a 1.8 mm blank pitch as low as 372 mm may be realized in the illustrated embodiment.

In an exemplary door application, Table 1 shows relative mass savings for trimmed draw inners 10 contrasting conventional production inners against other mass reduction methods including the present non-linear weld line method:

TABLE 1

| | Total Mass | Net Savings |
|---|---|---|
| Door Inner Weld Configuration | (kg) | (kg) |
| Conventional Production 3PC | 8.86 | — |
| 50 mm forward shift-Linear Weld 4PC | 8.73 | 0.13 |
| 100 mm forward shift-Linear Weld 4PC | 8.54 | 0.32 |
| Non-linear weld w/controlled split 3PC | 8.31 | 0.55 |

Thus, from Table 1, the usage of the proposed non-linear welded blank with controlled split resulted in a reduction in the 1.8 mm blank 12 equal to 0.55 kg per door, or 2.0 kg per 4-door vehicle (not shown). Moreover, a sampling of the blank mass reduction of the 1.8 mm stock with a controlled split engaged at 8 and 10 mm off bottom of draw stroke was observed and predicted to provide net mass savings of 0.80, and 1.01 kg, respectively. The data was taken from a configuration where the weld line 16 was shifted forward from the buy-point an additional 12 mm, and for the 8 and 10 mm split engagements, the pitch was able to be additionally reduced by 25 mm while still meeting the formability requirements. Moreover, it was observed that the maximum thinning in the thin blank 14 at the weld line 16 on bottom of stroke was 19%, and that engaging the controlled split at 8 mm off bottom resulted in a maximum thinning on bottom of 17%. Therefore, it is appreciated that using a timing window to engage the controlled split device 22 between 6 and 10 mm off bottom of draw stroke results in additional robustness of the formability and additional mass and blank savings with the non-linear welded blank.

As shown in Table 1, shifted linear welds also exhibit mass savings, however, as previously mentioned, they require additional draw die, and/or tonnage pads to go from 80 to 120 tons of necessarily applied force. Moreover, it is appreciated that TWB's constructed with shifted linear welds do not pass formability requirements.

To effect raw material savings it follows that the reduction in the thick blank 12 must offset the penalty increase in the 0.8 mm material as a result of the forward change in location of the weld line 16. In the particular sampling, it was observed that a penalty increase of the 0.8 mm blank 14 of 0.69 kg resulted from the increase of material pitch dimension for the nesting of a two-out blank as is conventionally presented for a production door. That is to say, the convex portion of the blank 14 under a non-linear weld requires a wider starting blank. It is appreciated that a two-out blank is presented, such that per blank, the net penalty increase in mass of blank is 0.69/2 or approximately 0.35 kg.

When subtracting the thin blank penalty of 0.35 kg from the thick blank savings previously mentioned, it is appreciated that net mass savings up to 0.66 kg can be realized using the inventive method. It is also appreciated that the net cost savings resulting from the present invention depends upon the capitalized cost of the blanking and fixture costs for the TWB manufacturing, and the resultant piece cost increase of the TWB welding of the non-linear blank.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

Also, as used herein, the terms “first”, “second”, and the like do not denote any order or importance, but rather are used to distinguish one element from another, and the terms “the”, “a”, and “an” do not denote a limitation of quantity, but rather denote the presence of at least one of the referenced item. All ranges directed to the same quantity of a given component or measurement is inclusive of the endpoints and independently combinable.

What is claimed is:

1. A structural inner adapted for use with an exterior structural housing, and produced by a draw die process, said inner comprising:
a plurality of metal sections defining a plurality of differing thickness, wherein the sections are joined by a non-linear weld line configured to produce a concavity within a first section defining the greatest thickness and a convex profile within a second section defining the least thickness, and to reduce strain experienced adjacent the line during the process.

2. The inner as claimed in claim 1, wherein the inner defines a height and the concavity and profile are cooperatively configured to produce a sinuous weld section within the lower third of the height.

3. The inner as claimed in claim 1, wherein the housing is a vehicular door.

4. The inner as claimed in claim 3, wherein the first section presents a 1.8 mm thickness and the second section presents a 0.8 mm thickness.

5. The inner as claimed in claim 1, wherein the inner defines a height, the process produces a maximum stress portion along the height, and the weld line is configured so as to present a sinuous weld within the maximum stress portion.

6. The inner as claimed in claim 1, wherein the second section defines a controlled split at a predetermined location.

7. The inner as claimed in claim 6, wherein the housing is a vehicular door, and the second section defines and the split is caused to form adjacent a speaker hole.

8. The inner as claimed in claim 1, wherein the weld line comprises two bends, and three straight segments that cooperatively define three angles.

9. The inner as claimed in claim 8, wherein the angles include a first angle, a1, equal to 0 plus or minus 15 degrees, a second angle, a2, equal to 70 plus or minus 15 degrees, and a third angle, a3, equal to 0 plus or minus 15 degrees.

10. The inner as claimed in claim 8, wherein each bend is formed by a radius of 100 plus or minus 50 mm.

11. The inner as claimed in claim 8, wherein the weld line is defined by four bends, and five straight segments.

12. A structural inner adapted for use with an exterior vehicular door housing, and produced by a draw die process, said inner comprising:
a plurality of metal sections defining a plurality of differing thickness, wherein the sections are joined by a non-linear weld line configured to produce a concavity within a first section defining the greatest thickness and a convex profile within a second section defining the least thickness, and to reduce strain experienced adjacent the line during the process,
wherein the inner defines a height, the process produces a maximum stress portion along the height, and the weld line is configured so as to present a sinuous weld within the maximum stress portion,
wherein the second section defines and a controlled split is caused to form adjacent a speaker hole.

13. A method of constructing a structural inner utilizing a three-piece draw die, said method comprising:
a. securing a plurality of metal blanks having differing thickness relative to the draw die, wherein a first blank presents a maximum thickness and convex profile, a second blank presents a minimum thickness and concavity, the profile and concavity are mated so as to present a continuous interface;
b. forming a non-linear weld along the interface, so as to join the blanks and produce a tailor welded blank;
c. securing the tailor welded blank relative to the draw die; and
d. drawing the tailor welded blank to a predetermined configuration during a stamping process, so as to form the inner.

14. The method as claimed in claim 13, wherein the draw die includes a control split device, and steps c) and d) further include the steps of positioning the device relative to the tailor welded blank, and causing a localized failure at a predetermined location in the tailor welded blank during the process;

15. The method as claimed in claim 14, wherein the split device engages the tailor welded blank within a predetermined timing window.

16. The method as claimed in claim 15, wherein the window is 6 to 10 mm from the end of the process.

17. The method as claimed in claim 15, wherein the second blank defines a speaker hole, and the predetermined location is adjacent the hole.
